(19) United States
(12) Patent Application Publication
(10) Pub. No.: US 2025/0337443 A1
(43) Pub. Date: Oct. 30, 2025

(54) WIRELESS COMMUNICATION DEVICE AND OPERATING METHOD THEREOF

(71) Applicant: Realtek Semiconductor Corporation, Hsinchu (TW)

(72) Inventors: Hung-Yuan YANG, Hsinchu (TW); Ching-Wei LING, Hsinchu (TW)

(21) Appl. No.: 19/176,193

(22) Filed: Apr. 11, 2025

(30) Foreign Application Priority Data
Apr. 25, 2024 (TW) 113115565

(51) Int. Cl. H04B 1/10

(52) U.S. Cl. CPC H04B 1/109

(57) ABSTRACT

A wireless communication device is provided. A wireless communication device includes a first antenna, a second antenna and a power combiner. The first antenna, the second antenna, and a disturbance source have a fixed position relationship. The power combiner is coupled with the first antenna and the second antenna through a first signal path and a second signal path, respectively. The power combiner receives a first noise and a second noise induced by the disturbance source through the first signal path and the second signal path, respectively. The power combiner further combines the first noise and the second noise. Based on the fixed position relationship, the first noise and the second noise received by the power combiner have a target phase difference and a target amplitude ratio so that the first noise and the second noise form a destructive interference at the power combiner.

### RELATED APPLICATIONS

This application claims priority to Taiwan Application Serial Number 113115565, filed on Apr. 25, 2024, which is herein incorporated by reference.

### BACKGROUND

### Field of Invention

This disclosure relates to a wireless communication technology, in particular to a wireless communication device capable of instantly suppressing interference and an operating method thereof.

### Description of Related Art

With the vigorous development of wireless communication, users' requirements for data transmission bandwidth of wireless communication products are increasing day by day. Therefore, most Interfaces for external data transmission of current wireless communication products are high-speed digital transmission interfaces, such as Universal Serial Bus (USB) 3.2, Peripheral Component Interconnect Express (PCI-E) or Thunderbolt. However, the high-speed clock signal used by the high-speed digital transmission interface may interfere with the wireless communication signal and even cause blockage. In addition, in the situation where the wireless communication product is a controlled slave device (e.g., a wireless network card), the wireless communication signal may be interfered when the host is accessed through the high-speed digital transmission interface, but the wireless communication product may not predict the time of host access, and thus the interference suppression mechanism may not be activated in advance.

### SUMMARY

An aspect of present disclosure relates to a wireless communication device, including a first antenna, a second antenna and a power combiner. The first antenna, the second antenna and a disturbance source have a fixed position relationship. The power combiner is coupled with the first antenna and the second antenna through a first signal path and a second signal path, respectively. The power combiner is configured to receive a first noise and a second noise induced by the disturbance source through the first signal path and the second signal path, respectively. The power combiner is further configured to combine the first noise and the second noise. Based on the fixed position relationship, the first noise and the second noise received by the power combiner have a target phase difference and a target amplitude ratio so that the first noise and the second noise form a destructive interference at the power combiner.

Another aspect of present disclosure relates to an operating method suitable for a wireless communication device. The wireless communication device comprises a first antenna, a second antenna and a power combiner. The first antenna, the second antenna and a disturbance source have a fixed position relationship. The power combiner is coupled with the first antenna and the second antenna through a first signal path and a second signal path, respectively. The operating method includes the following steps: receiving a first noise and a second noise induced by the disturbance source from the first signal path and the second signal path, respectively, through the power combiner; and combining the first noise and the second noise through the power combiner. Based on the fixed position relationship, the first noise and the second noise received by the power combiner have a target phase difference and a target amplitude ratio so that the first noise and the second noise form a destructive interference at the power combiner.

One of the advantages of the above-mentioned wireless communication device and operating method is that interference caused by noise with characteristics such as random generation, high frequency, and amplitude time-varying may be instantly suppressed.

It is to be understood that both the foregoing general description and the following detailed description are by examples, and are intended to provide further explanation of the invention as claimed.

### BRIEF DESCRIPTION OF THE DRAWINGS

The present disclosure can be more fully understood by reading the following detailed description of the embodiment, with reference made to the accompanying drawings as follows:

FIG. 1 is a simplified functional block diagram of a wireless communication device in accordance with an embodiment of the present disclosure;

FIG. 2A is a simplified functional block diagram of a wireless communication device in accordance with an embodiment of the present disclosure;

FIG. 2B is a simplified functional block diagram of a wireless communication device in accordance with another embodiment of the present disclosure;

FIG. 3 is a simplified functional block diagram of a wireless communication device in accordance with an embodiment of the present disclosure;

FIG. 4 is a simplified flow diagram of an operating method in accordance with an embodiment of the present disclosure.

### DETAILED DESCRIPTION

The embodiments of the present disclosure will be described below with reference to the relevant drawings. In the drawings, the same reference numbers represent the same or similar components or method flows.

The embodiments are described in detail below with reference to the appended drawings to better understand the aspects of the present application. However, the provided embodiments are not intended to limit the scope of the disclosure, and the description of the structural operation is not intended to limit the order in which they are performed. Any device that has been recombined by components and produces an equivalent function is within the scope covered by the disclosure.

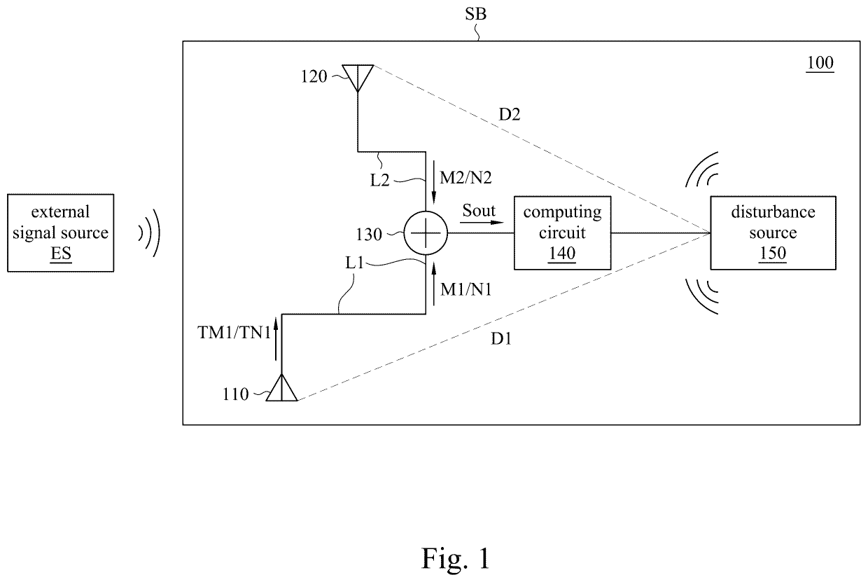

FIG. 1 is a simplified functional block diagram of a wireless communication device 100 in accordance with an embodiment of the present disclosure. The wireless communication device 100 includes a substrate SB, and includes a first antenna 110, a second antenna 120, a power combiner 130, a computing circuit 140 and a disturbance source 150 which are disposed on the substrate SB. The first antenna 110, the second antenna 120 and the disturbance source 150 have a fixed position relationship. For example, when the disturbance source 150 is used as a reference point, the first antenna 110 and the second antenna 120 are at fixed relative positions relative to the disturbance source 150. The disturbance source 150 is coupled to the computing circuit 140 and is used to communicatively connect the computing circuit 140 to an external computing device (not shown, such as a personal computer). In some embodiments, the wireless communication device 100 may be a wireless network card, and the disturbance source 150 may be a high-speed digital transmission interface, for example, electronic devices such as Universal Serial Bus (USB) 3.2, Peripheral Component Interconnect Express (PCI-E) or Thunderbolt.

The power combiner 130 is coupled with the first antenna 110 and the second antenna 120 through a first signal path L1 and a second signal path L2, respectively. When the first antenna 110 and the second antenna 120 are subject to wireless interference from the disturbance source 150, the first antenna 110 and the second antenna 120 generate a first noise N1 and a second noise N2, respectively. The power combiner 130 is configured to receive the first noise N1 and the second noise N2 induced by the disturbance source 150 through the first signal path L1 and the second signal path L2, respectively. The power combiner 130 is further configured to combine the first noise N1 and the second noise N2.

Based on the fixed position relationship among the first antenna 110, the second antenna 120 and the disturbance source 150, the first noise N1 and the second noise N2 received by the power combiner 130 have a target phase difference and a target amplitude ratio so that the first noise N1 and the second noise N2 form a destructive interference at the power combiner 130, thereby improving signal-to-noise ratios of the first antenna 110 and the second antenna 120. The fixed position relationship may include the following conditions: (1) the first antenna 110 is spaced from the disturbance source 150 by a first distance D1; and (2) the second antenna 120 is spaced from the disturbance source 150 by a second distance D2. In some embodiments, the target phase difference is between −160 and −180 degrees or between 160 and 180 degrees. In other embodiments, the target amplitude ratio ranges from 1:0.8 to 1:1.2. Because the first noise N1 and the second noise N2 are substantially out of phase and have the same amplitude when transmitted to the power combiner 130, the destructive interference is formed when the first noise N1 and the second noise N2 are combined at the power combiner 130.

In order to increase design flexibility, in some embodiments, the phase and amplitude of the first noise N1 which is transmitted to the power combiner 130 may be determined not only by adjusting the first distance D1 but also by adjusting the length of the first signal path L1. Similarly, the phase and amplitude of the second noise N2 which is transmitted to the power combiner 130 may be determined by adjusting the second distance D2 and the length of the second signal path L2. In summary, based on the fixed position relationship, the length of the first signal path L1 and the length of the second signal path L2, the first noise N1 and the second noise N2 received by the power combiner 130 have the target phase difference and the target amplitude ratio.

In addition, when the first antenna 110 and the second antenna 120 receive wireless signals from an external signal source ES (e.g., Wi-Fi base station), the first antenna 110 and the second antenna 120 generate a first main signal M1 and a second main signal M2, respectively. The power combiner 130 is configured to receive the first main signal M1 and the second main signal M2 induced by the external signal source ES through the first signal path L1 and the second signal path L2, respectively. The power combiner 130 is further configured to combine the first main signal M1 and the second main signal M2, so that the first main signal M1 and the second main signal M2 form a constructive combination at the power combiner 130, thereby improving signal-to-noise ratio.

Based on the relationship among the first antenna 110, the second antenna 120, the first signal path L1 and the second signal path L2, the destructive interference may occur when the signal source is in a specific area. This specific area may be regarded as a communication blind zone of the wireless communication device 100. In one embodiment, the position of the communication blind zone may be adjusted by adjusting the length of the first signal path L1 or the second signal path L2, so that the disturbance source 150 enters the aforementioned communication blind zone (forming the destructive interference), thereby making the first noise N1 and the second noise N2 cancel each other. On the other hand, since the external signal source ES is spaced from the wireless communication device 100 by a considerable distance (e.g., the Wi-Fi base station is usually tens of centimeters or several meters away from the personal computer), the position of the communication blind zone may be adjusted by adjusting the length of the first signal path L1 or the second signal path L2, so that the external signal source ES is outside the communication blind zone of the wireless communication device 100, thereby making the first main signal M1 and the second main signal M2 form the constructive combination at the power combiner 130.

The power combiner 130 is configured to generate an output signal Sout to the computing circuit 140 based on the first main signal M1, the second main signal M2, the first noise N1 and the second noise N2. The computing circuit 140 is configured to perform signal processing on the output signal Sout, such as demodulation, filtering, and analog-to-digital conversion. The disturbance source 150 (e.g., a high-speed digital communication interface) may then output the result obtained by the signal processing of the computing circuit 140 to the outside.

In summary, by the dual-antenna design, the wireless communication device 100 may simultaneously suppress noise and increase the amplitude of the main signal, thereby improving signal-to-noise ratio. In addition, since the wireless communication device 100 makes the two noise signals received by the two antennas cancel each other, the wireless communication device 100 may suppress interference immediately even if the content of the noise has characteristics such as random generation, high frequency, and time-varying amplitude.

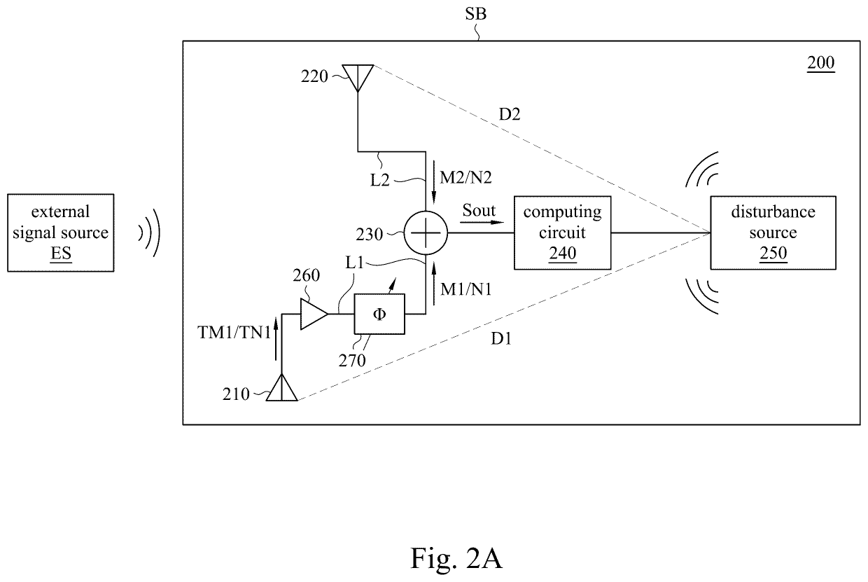

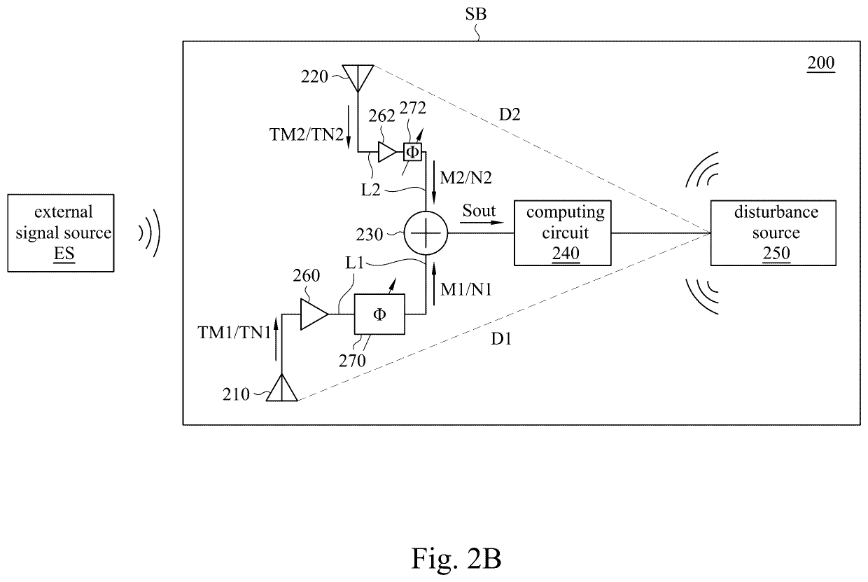

FIG. 2A is a simplified functional block diagram of a wireless communication device 200 in accordance with an embodiment of the present disclosure. The first antenna 210, the second antenna 220, the power combiner 230, the computing circuit 240 and the disturbance source 250 of the wireless communication device 200 are similar to the corresponding functional blocks or components of the wireless communication device 100 of FIG. 1, respectively. For the sake of simplicity, they will not be repeated herein.

The wireless communication device 200 further includes at least one of a first amplitude control circuit 260 and a first phase control circuit 270. The at least one of the first amplitude control circuit 260 and the first phase control circuit 270 is disposed on the first signal path L1 and is coupled between the first antenna 210 and the power combiner 230. In an embodiment where the wireless communication device 200 includes both the first amplitude control circuit 260 and the first phase control circuit 270, the first amplitude control circuit 260 and the first phase control circuit 270 are coupled in series between the first antenna 210 and the power combiner 230.

In some embodiments, the first distance D1, the second distance D2, the length of the first signal path L1 and/or the length of the second signal path L2 may not be designed to make the first noise N1 and the second noise N2 form the destructive interference at the power combiner 230 due to layout limitations. In this situation, the first amplitude control circuit 260 and the first phase control circuit 270 may improve design flexibility of the wireless communication device 200, which would be described in the following paragraphs.

It should be supplemented that based on the fixed position relationship among the first antenna 110, the second antenna 120 and the disturbance source 150, the output signal Sout is generated by combing the signals received via the first antenna 110 and the second antenna 120. The noise components of the output signal Sout (which includes the first noise N1 and the second noise N2) may be described by the following formula:

$$Noise components of Sout = N 1 + N 2 = {a}_{0} cos x + {a}_{1} cos y$$

In the above formula, a₀ is the amplitude of the first noise N1, x is the phase of the first noise N1, a₁ is the amplitude of the second noise N2, and y is the phase of the second noise N2. As described in the above embodiment, if a₀=a₁ and x=y+180° are satisfied, the first noise N1 and the second noise N2 would form the destructive interference so that a₀ cos x+a₁ cos y=0, that is, the noise components of the output signal Sout become zero.

It should be supplemented that some embodiments of the present disclosure are illustrated by adjusting the first antenna 110 and the second antenna 120 to form the destructive interference therebetween. In other embodiments, the present disclosure is not limited to two antennas. For example, the wireless communication device 200 may also include three antennas (or more antennas). In this example, the noise components of the output signal Sout may be represented by the following formula:

$$Noise components of Sout = N 1 + N 2 + N 3 = {a}_{0} cos x + {a}_{1} cos y + {a}_{2} cos z$$

In this situation, a₀ is the amplitude of the first noise N1, x is the phase of the first noise N1, a₁ is the amplitude of the second noise N2, y is the phase of the second noise N2, a₂ is the amplitude of the third noise N3 (not shown in the figure) of the third antenna, z is the phase of the third noise N3 (not shown in the figure). In this example, as described in the above embodiment, if a₀=a₁=0.5*a₂ and x=y=z+180° are satisfied, a₀ cos x+a₁ cos y+a₂ cos z=0 is made, that is, the noise components of the output signal Sout become zero. In other words, other embodiments of the present disclosure may achieve the effect of suppressing noise by more antennas.

For simplicity of description, in the following embodiments of the present disclosure, the descriptions are made by an example of generating the output signal Sout by combing the signals received via the first antenna 110 and the second antenna 120. However, the present disclosure may be applied to scenarios with two or more antennas.

The first amplitude control circuit 260 is configured to adjust the amplitude of the signal output by the first antenna 210. The first phase control circuit 270 is configured to adjust the phase of the signal output by the first antenna 210. In some embodiments, the first amplitude control circuit 260 may be implemented by an amplifier. In other embodiments, the first phase control circuit 270 may be implemented by a phase shifter (e.g., an inductor-capacitor circuit). When the first antenna 210 generates a first pending noise TN1 induced by the disturbance source 250, the at least one of the first amplitude control circuit 260 and the first phase control circuit 270 is configured to convert the first pending noise TN1 into the first noise N1. By designing (adjusting) an appropriate gain value for the first amplitude control circuit 260, and/or designing (adjusting) appropriate phase shift value, capacitance value and inductance value for the first phase control circuit 270, the first noise N1 and the second noise N2 may have the aforementioned target phase difference and target amplitude ratio.

In other words, based on the aforementioned fixed position relationship, the length of the first signal path L1, the length of the second signal path L2 and the circuit configuration of the at least one of the first amplitude control circuit 260 and the first phase control circuit 270, the first noise N1 and the second noise N2 have the target phase difference and the target amplitude ratio so that the destructive interference may be formed at the power combiner 230. In addition, when the first antenna 210 generates the first pending main signal TM1 induced by the external signal source ES, the at least one of the first amplitude control circuit 260 and the first phase control circuit 270 is configured to convert the first pending main signal TM1 into the first main signal M1, so that the first main signal M1 and the second main signal M2 form the constructive combination at the power combiner 230.

To further improve design flexibility, in some embodiments, the wireless communication device 200 includes not only at least one of the first amplitude control circuit 260 and the first phase control circuit 270 shown in FIG. 2A but also at least one of a second amplitude control circuit and a second phase control circuit. Please refer to FIG. 2B together, FIG. 2B is a simplified functional block diagram of a wireless communication device in accordance with another embodiment of the present disclosure. As shown in FIG. 2B, the at least one of the second amplitude control circuit 262 and the second phase control circuit 272 is disposed on the second signal path L2 and coupled between the second antenna 220 and the power combiner 230. In an embodiment where the wireless communication device 200 includes both the second amplitude control circuit 262 and the second phase control circuit 272, the second amplitude control circuit 262 and the second phase control circuit 272 are coupled in series between the second antenna 220 and the power combiner 230. The structures and functions of the second amplitude control circuit 262 and the second phase control circuit 272 are similar to those of the first amplitude control circuit 260 and the first phase control circuit 270, respectively. When the second antenna 220 generates the second pending noise TN2 induced by the disturbance source 250, the at least one of the second amplitude control circuit 262 and the second phase control circuit 272 is configured to convert the second pending noise TN2 into the second noise N2, so that the first noise N1 and the second noise N2 form the destructive interference at the power combiner 230.

Therefore, as shown in FIG. 2B, based on the aforementioned fixed position relationship, the length of the first signal path L1, the length of the second signal path L2, the circuit configuration of the at least one of the first amplitude control circuit 260 and the first phase control circuit 270 and the circuit configuration of the at least one of the second amplitude control circuit 262 and the second phase control circuit 272, the first noise N1 and the second noise N2 have the target phase difference and the target amplitude ratio. In addition, when the second antenna 220 generates the second pending main signal induced by the external signal source ES, the at least one of the second amplitude control circuit 262 and the second phase control circuit 272 is configured to convert the second pending main signal TM2 into the second main signal M2, so that the first main signal M1 and the second main signal M2 form the constructive combination at the power combiner 230.

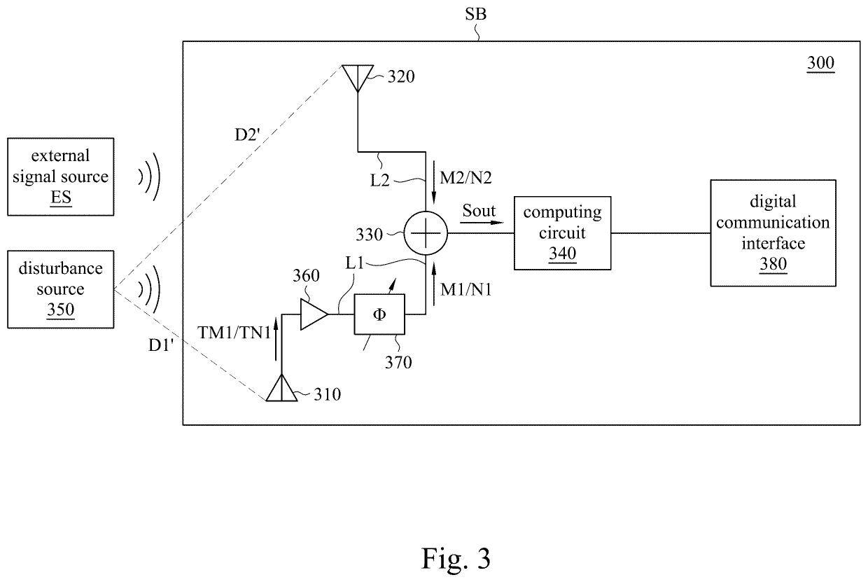

FIG. 3 is a simplified functional block diagram of a wireless communication device 300 in accordance with an embodiment of the present disclosure. The first antenna 310, the second antenna 320, the power combiner 330, the first signal path L1, the second signal path L2, the first amplitude control circuit 360 and the first phase control circuit 370 of the wireless communication device 300 are similar to the corresponding functional blocks or components in the wireless communication device 200 of FIG. 2A, respectively. For the sake of simplicity, they will not be repeated herein. In addition, the wireless communication device 300 includes at least one of the first amplitude control circuit 360 and the first phase control circuit 370, which is similar to those described in FIG. 2A.

The function of the digital communication interface 380 of the wireless communication device 300 is similar to the disturbance source 250 of FIG. 2A, but the digital communication interface 380 may not interfere with the first antenna 310 and the second antenna 320. In the embodiment of FIG. 3, the pending noise TN1 (or the first noise N1) and the second noise N2 are mainly induced by the disturbance source 350, and the disturbance source 350 is outside the wireless communication device 300. The computing circuit 340 of the wireless communication device 300 is configured to analyze the disturbance source 350 to adaptively adjust the circuit configuration (e.g., the aforementioned gain value, the capacitance value and/or the inductance value) of the at least one of the first amplitude control circuit 360 and the first phase control circuit 370, so that the first noise N1 and the second noise N2 may form the destructive interference at the power combiner 330. It is worth mentioning that the disturbance source 350 has a fixed position, so there is still a fixed position relationship among the first antenna 310, the second antenna 320 and the disturbance source 350. For example, the first antenna 310 is spaced from the disturbance source 350 by a first distance D1′, and the second antenna 320 is spaced from the disturbance source 350 by a second distance D2′, where the first distance D1′ and the second distance D2′ are fixed values.

Specifically, the computing circuit 340 may first determine whether the disturbance source 350 is a known disturbance source. For example, the computing circuit 340 may first reset the circuit configuration of the at least one of the first amplitude control circuit 360 and the first phase control circuit 370, and then analyze at least the frequencies, amplitudes and/or packet headers of the first noise N1 and the second noise N2 to determine whether the characteristics of the disturbance source 350 match any disturbance source recorded in the computing circuit 340.

When the computing circuit 340 determines that the disturbance source 350 is the known disturbance source, the computing circuit 340 is configured to adjust the circuit configuration of the at least one of the first amplitude control circuit 360 and the first phase control circuit 370 to a default configuration corresponding to the disturbance source 350 (for example, the gain value, the capacitance value and/or the inductance value prerecorded in the computing circuit 340 with a lookup table). In this way, based on the default configuration and the fixed position relationship, the first noise N1 and the second noise N2 have the target phase difference and the target amplitude ratio, and thus the destructive interference may be formed at the power combiner 330.

On the other hand, when the computing circuit 340 determines that the disturbance source 350 is an unknown disturbance source, the computing circuit 340 is configured to adjust the circuit configuration of the at least one of the first amplitude control circuit 360 and the first phase control circuit 370 until the first noise N1 and the second noise N2 have a target phase difference and a target amplitude ratio based on the fixed position relationship and the adjusted circuit configuration. For example, the computing circuit 340 may sequentially increase or decrease the gain value, the capacitance value and/or the inductance value of the at least one of the first amplitude control circuit 360 and the first phase control circuit 370.

In addition, as described above, the length of the first signal path L1 and the length of the second signal path L2 may affect the amplitudes and phases of the first noise N1 and the second noise N2. Therefore, in some embodiments, in the situation where the disturbance source 350 is the known disturbance source, based on the fixed position relationship, the default configuration, the length of the first signal path L1 and the length of the second signal path L2, the first noise N1 and the second noise N2 received by the power combiner 330 have the target phase difference and the target amplitude ratio. In other embodiments, in the situation where the disturbance source 350 is the unknown disturbance source, based on the fixed position relationship, the adjusted circuit configuration, the length of the first signal path L1 and the length of the second signal path L2, the first noise N1 and the second noise N2 received by the power combiner 330 have the target phase difference and the target amplitude ratio.

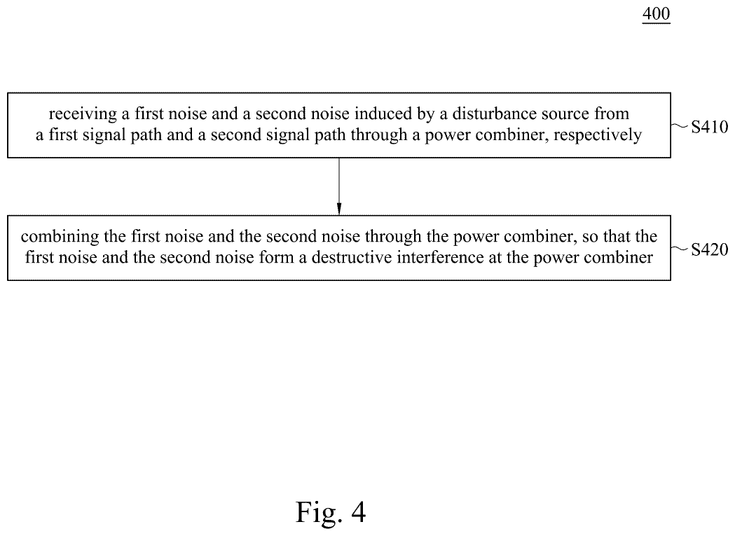

FIG. 4 is a simplified flow diagram of an operating method 400 in accordance with an embodiment of the present disclosure. Any combination of features of the operating method 400 may be implemented as a plurality of instructions stored in a non-transitory computer-readable storage medium. When executed by one or more processors (e.g., a computing circuits 140, 240 and 340), the instructions cause the one or more processors to perform part or all of the operating method 400. The operating method 400 is applicable to the wireless communication devices 100, 200 and 300 of FIGS. 1 to 3. The wireless communication device 100 is first taken as an example for description below.

In step S410, a power combiner 130 receives a first noise N1 and a second noise N2 induced by a disturbance source 150 from a first signal path L1 and a second signal path L2, respectively. Based on a fixed position relationship among a first antenna 110, a second antenna 120 and the disturbance source 150, the first noise N1 and the second noise N2 received by the power combiner 130 have a target phase difference and a target amplitude ratio. In some embodiments, the target phase difference is between −160 and −180 degrees, or between 160 and 180 degrees. In some embodiments, the target amplitude ratio ranges from 1:0.8 to 1:1.2.

In step S420, the power combiner 130 combines the first noise N1 and the second noise N2, so that the first noise N1 and the second noise N2 form a destructive interference at the power combiner 130.

In some embodiments, in the situation where the wireless communication device 200 in FIG. 2A performs the operating method 400 and includes at least one of a first amplitude control circuit 260 and a first phase control circuit 270, the step S410 includes: when the first antenna 210 generates a first pending noise TN1 induced by a disturbance source 250, converting the first pending noise TN1 into the first noise N1 by the at least one of the first amplitude control circuit 260 and the first phase control circuit 270.

In other embodiments, the wireless communication device 200 as shown in FIG. 2B includes not only the first amplitude control circuit 260 and the first phase control circuit 270 (coupled between the first antenna 210 and the power combiner 230) but also at least one of a second amplitude control circuit 262 and a second phase control circuit 272. The second amplitude control circuit 262 and the second phase control circuit 272 may be coupled between the second antenna 220 and the power combiner 230, and similar to the first amplitude control circuit 260 and the first phase control circuit 270, respectively. The step S410 further includes: when the second antenna 220 generates a second pending noise TN2 induced by the disturbance source 250, converting the second pending noise TN2 into the second noise N2 by the at least one of the second amplitude control circuit 262 and the second phase control circuit 272.

In addition, referring to FIG. 2A and FIG. 2B together, the operating method 400 may further include: receiving the first main signal M1 and the second main signal M2 induced by an external signal source ES from the first signal path L1 and the second signal path L2 through the power combiner 230, respectively. The main signal M1 and the second main signal M2. The first main signal M1 and the second main signal M2 are combined through the power combiner 230, so as to form a constructive combination at the power combiner 230.

In some embodiments, in the situation where the wireless communication device 300 in FIG. 3 performs the operating method 400, the step S410 includes: (1) In response to the computing circuit 340 determining that a disturbance source 350 is a known disturbance source, adjusting a circuit configuration of the at least one of the first amplitude control circuit 360 and the first phase control circuit 370 to a default configuration corresponding to the known disturbance source, so that the first noise N1 and the second noise N2 have a target phase difference and a target amplitude ratio based on a fixed position relationship among a first antenna 310, a second antenna 320 and the disturbance source 350 and the default configuration; and (2) in response to the computing circuit 340 determining that the disturbance source 350 is an unknown disturbance source, adjusting the circuit configuration of the at least one of the first amplitude control circuit 360 and the first phase control circuit 370 through the computing circuit 340 until the first noise N1 and the second noise N2 have a target phase difference and a target amplitude ratio based on the fixed position relationship and the adjusted circuit configuration. In one embodiment, the disturbance source 350 may be a digital transmission interface of the wireless communication device.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A wireless communication device, comprising:
a first antenna;
a second antenna, wherein the first antenna, the second antenna and a disturbance source have a fixed position relationship; and
a power combiner, coupled with the first antenna and the second antenna through a first signal path and a second signal path, respectively, configured to receive a first noise and a second noise induced by the disturbance source through the first signal path and the second signal path, respectively, and configured to combine the first noise and the second noise;
wherein based on the fixed position relationship, the first noise and the second noise received by the power combiner have a target phase difference and a target amplitude ratio so that the first noise and the second noise form a destructive interference at the power combiner.

2. The wireless communication device of claim 1, wherein the target phase difference is between −160 and −180 degrees or between 160 and 180 degrees.

3. The wireless communication device of claim 1, wherein the target amplitude ratio ranges from 1:0.8 to 1:1.2.

4. The wireless communication device of claim 1, wherein based on the fixed position relationship, a length of the first signal path and a length of the second signal path, the first noise and the second noise received by the power combiner have the target phase difference and the target amplitude ratio.

5. The wireless communication device of claim 1, further comprising at least one of a first amplitude control circuit and a first phase control circuit, wherein the at least one of the first amplitude control circuit and the first phase control circuit is disposed on the first signal path and coupled between the first antenna and the power combiner;
wherein when the first antenna generates a first pending noise induced by the disturbance source, the at least one of the first amplitude control circuit and the first phase control circuit is configured to convert the first pending noise into the first noise.

6. The wireless communication device of claim 5, further comprising at least one of a second amplitude control circuit and a second phase control circuit, wherein the at least one of the second amplitude control circuit and the second phase control circuit is disposed on the second signal path and coupled between the second antenna and the power combiner;
wherein when the second antenna generates a second pending noise induced by the disturbance source, the at least one of the second amplitude control circuit and the second phase control circuit is configured to convert the second pending noise into the second noise.

7. The wireless communication device of claim 5, wherein the disturbance source is outside the wireless communication device, the wireless communication device further comprises a computing circuit, the computing circuit is configured to:
in response to determining that the disturbance source is a known disturbance source, adjusting a circuit configuration of the at least one of the first amplitude control circuit and the first phase control circuit to a default configuration corresponding to the known disturbance source, so that the first noise and the second noise have the target phase difference and the target amplitude ratio based on the fixed position relationship and the default configuration; and
in response to determining that the disturbance source is an unknown disturbance source, adjusting the circuit configuration of the at least one of the first amplitude control circuit and the first phase control circuit until the first noise and the second noise have the target phase difference and the target amplitude ratio based on the fixed position relationship and the adjusted circuit configuration.

8. The wireless communication device of claim 7, wherein when the disturbance source is the known disturbance source, based on the fixed position relationship, the default configuration, a length of the first signal path and a length of the second signal path, the first noise and the second noise received by the power combiner have the target phase difference and the target amplitude ratio;
wherein when the disturbance source is the unknown disturbance source, based on the fixed position relationship, the adjusted circuit configuration, the length of the first signal path and the length of the second signal path, the first noise and the second noise received by the power combiner have the target phase difference and the target amplitude ratio.

9. The wireless communication device of claim 1, wherein the disturbance source is a digital transmission interface of the wireless communication device.

10. The wireless communication device of claim 1, wherein the power combiner is configured to receive a first main signal and a second main signal induced by an external signal source through the first signal path and the second signal path, respectively, and configured to combine the first main signal and the second main signal, so that the first main signal and the second main signal form a constructive combination at the power combiner.

11. An operating method suitable for a wireless communication device, wherein the wireless communication device comprises a first antenna, a second antenna and a power combiner, wherein the first antenna, the second antenna and a disturbance source have a fixed position relationship, the power combiner is coupled with the first antenna and the second antenna through a first signal path and a second signal path, respectively, the operating method comprises:
receiving a first noise and a second noise induced by the disturbance source from the first signal path and the second signal path, respectively, through the power combiner; and
combining the first noise and the second noise through the power combiner;
wherein based on the fixed position relationship, the first noise and the second noise received by the power combiner have a target phase difference and a target amplitude ratio so that the first noise and the second noise form a destructive interference at the power combiner.

12. The operating method of claim 11, wherein the target phase difference is between −160 and −180 degrees or between 160 and 180 degrees.

13. The operating method of claim 11, wherein the target amplitude ratio ranges from 1:0.8 to 1:1.2.

14. The operating method of claim 11, wherein based on the fixed position relationship, a length of the first signal path and a length of the second signal path, the first noise and the second noise received by the power combiner have the target phase difference and the target amplitude ratio.

15. The operating method of claim 11, wherein the wireless communication device further comprises at least one of a first amplitude control circuit and a first phase control circuit, the at least one of the first amplitude control circuit and the first phase control circuit is disposed on the first signal path and coupled between the first antenna and the power combiner, wherein receiving the first noise and the second noise induced by the disturbance source from the first signal path and the second signal path, respectively, through the power combiner comprises:
when the first antenna generates a first pending noise induced by the disturbance source, converting the first pending noise into the first noise through the at least one of the first amplitude control circuit and the first phase control circuit.

16. The operating method of claim 15, wherein the wireless communication device further comprises at least one of a second amplitude control circuit and a second phase control circuit, the at least one of the second amplitude control circuit and the second phase control circuit is disposed on the second signal path and coupled between the second antenna and the power combiner, wherein receiving the first noise and the second noise induced by the disturbance source from the first signal path and the second signal path, respectively, through the power combiner further comprises:
when the second antenna generates a second pending noise induced by the disturbance source, converting the second pending noise into the second noise through the at least one of the second amplitude control circuit and the second phase control circuit.

17. The operating method of claim 15, wherein the disturbance source is outside the wireless communication device, the wireless communication device further comprises a computing circuit, receiving the first noise and the second noise induced by the disturbance source from the first signal path and the second signal path, respectively, through the power combiner comprises:
in response to the computing circuit determining that the disturbance source is a known disturbance source, adjusting a circuit configuration of the at least one of the first amplitude control circuit and the first phase control circuit to a default configuration corresponding to the known disturbance source, so that the first noise and the second noise have the target phase difference and the target amplitude ratio based on the fixed position relationship and the default configuration; and
in response to the computing circuit determining that the disturbance source is an unknown disturbance source, adjusting the circuit configuration of the at least one of the first amplitude control circuit and the first phase control circuit until the first noise and the second noise have the target phase difference and the target amplitude ratio based on the fixed position relationship and the adjusted circuit configuration.

18. The operating method of claim 17, wherein when the disturbance source is the known disturbance source, based on the fixed position relationship, the default configuration, a length of the first signal path and a length of the second signal path, the first noise and the second noise received by the power combiner have the target phase difference and the target amplitude ratio;
wherein when the disturbance source is the unknown disturbance source, based on the fixed position relationship, the adjusted circuit configuration, the length of the first signal path and the length of the second signal path, the first noise and the second noise received by the power combiner have the target phase difference and the target amplitude ratio.

19. The operating method of claim 11, wherein the disturbance source is a digital transmission interface of the wireless communication device.

20. The operating method of claim 11, further comprising:
receiving a first main signal and a second main signal induced by an external signal source from the first signal path and the second signal path, respectively, through the power combiner, and
combining the first main signal and the second main signal through the power combiner, so that the first main signal and the second main signal form a constructive combination at the power combiner.
